(19) United States
(12) Patent Application Publication
(10) Pub. No.: US 2010/0124987 A1
(43) Pub. Date: May 20, 2010

(54) Random community bonus gaming system and method

(75) Inventor: Tyler Thomas Parham, Reno, NV (US)

Correspondence Address: NWAMU, P.C., 360 Grand Ave, Suite 109, Oakland, CA, 94610, US

(73) Assignee: GAMING ENHANCEMENTS, INC., RENO, NV (US)

(21) Appl. No.: 12/592,046

(22) Filed: Nov. 17, 2009

Related U.S. Application Data
(60) Provisional application No. 61/115,498, filed on Nov. 17, 2008.

(51) Int. Cl. A63F 9/24; A63F 13/00

(52) U.S. Cl. 463/26; 463/30; 463/42

(57) ABSTRACT

A random community bonus having a plurality of bonus awards. A threshold is randomly selected for awarding the community bonus. The random threshold may be the number of bonus awards that players qualify for. The bonus awards are displayed on a screen. A maximum of M number of awards, such as ten awards, may be shown on the screen. After the threshold is set, eligible players playing an underlying primary game are qualified for the community bonus. The number of qualified players cannot be more than the threshold value. A compensatory award can be received if a player opts out. A running count of eligible players that have qualified for the community bonus game is also displayed. When the number of eligible players or the number of bonus awards qualified for reaches the threshold value, the community bonus is triggered to award at least one bonus award to each and every qualified player.

### CLAIM OF PRIORITY

The present application claims priority from U.S. Provisional Patent Application Ser. No. 61/115,498, entitled “RANDOM COMMUNITY BONUS” filed on Nov. 17, 2008.

### BACKGROUND OF THE INVENTION

The present invention relates generally to casino gaming systems and methods and more specifically to casino gaming systems and methods for allowing individual gaming devices on a gaming network to play the same casino type game.

There are many different approaches for attracting players and maintaining player excitement and appeal for casino gaming devices such as video poker, slot machines and other casino type games. For example, progressive jackpots and/or bonuses may be employed. To make the jackpot progressive, multiple machines are typically networked together. As more players and machine coin-in increases, the progressive also increases. The networked machines are also provided the chance to win the progressive.

One problem with progressive jackpots is that they fail to continuously attract or retain player excitement and appeal. When a progressive jackpot is won, the progressive jackpot is reduced to a smaller amount. Users may not want to play the machines associated with the progressive until the progressive goes up in value. Accordingly, machines may experience slow times of play.

Some games also offer a bonus or a fixed pay table. When the bonus is won, the user may leave the gaming device because the likelihood (or perceived likelihood) of winning another bonus any time soon is low. A similar result occurs when a user wins a higher ranked award (e.g., a four of a kind), the user may leave the gaming device because a second high award is unlikely to be received on the same machine. This may result in reduced play at the gaming device.

There is a need to address one or more of the foregoing disadvantages of conventional systems and methods and the present invention meets this need.

### BRIEF SUMMARY OF THE INVENTION

Various aspects of a random community bonus gaming system and method can be found in exemplary embodiments of the present invention.

In a first embodiment, a method for awarding a random community bonus award is disclosed. This random community bonus award includes a number of individual bonus awards. The random community bonus award is one that can be awarded to a community of players based on qualification.

The present method is initiated by determining a threshold or trigger point for awarding the community bonus. The threshold or trigger point is a value used to determine when to award the community bonus. This trigger point value is randomly selected from a range of values, with the maximum value being the number of individual bonus awards that are allocated to the community bonus game. The maximum value is typically set and displayed for all of the eligible users at the inception of the community bonus game.

After the trigger point value is set, the bonus game is initiated and eligible players playing an underlying primary game are qualified to win the community bonus and the individual bonus awards. Here, eligible players are aware that they have qualified for the bonus award so they are unlikely to leave the gaming machine. Note that the number of qualified players cannot be more than the trigger point value.

One advantage of the present invention is that eligible players can opt-out before conclusion of the community bonus game and still receive a compensatory bonus award. Another advantage is that as each eligible player qualifies, the displayed bonus award values if masked can be unmasked so that eligible players become aware that they have qualified. Moreover, a running count of eligible players that have qualified for the community bonus game is also displayed.

When the number of eligible players or the number of bonus awards qualified for reaches the trigger point value, the community bonus is triggered to award at least one bonus award to each and every qualified player. In this manner, the present invention can attract new entrants while retaining current players.

Eligible players are also aware of the number of qualified players and the maximum number of individual bonus awards allocated to the community bonus game. However, because the threshold or trigger point is random, eligible players continue playing in anticipation knowing that the community bonus is awarded somewhere between the number of players currently qualified and the maximum bonus awards allocated to the random community bonus game. Users remain in the game knowing that the likelihood (or perceived likelihood) of winning a bonus is high.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 depicts a system for providing random community bonus awards according to an exemplary embodiment of the present invention.

FIG. 2 depicts a method in accordance with an exemplary embodiment of the present invention.

FIG. 3 depicts a flowchart for determining bonus awards according to an exemplary embodiment of the present invention.

FIG. 4 depicts a flowchart for allowing a qualified player to opt out of a community bonus game in accordance with an exemplary embodiment of the present invention.

FIG. 5 depicts a more detailed example of a controller of a network-based gaming system according to one embodiment.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

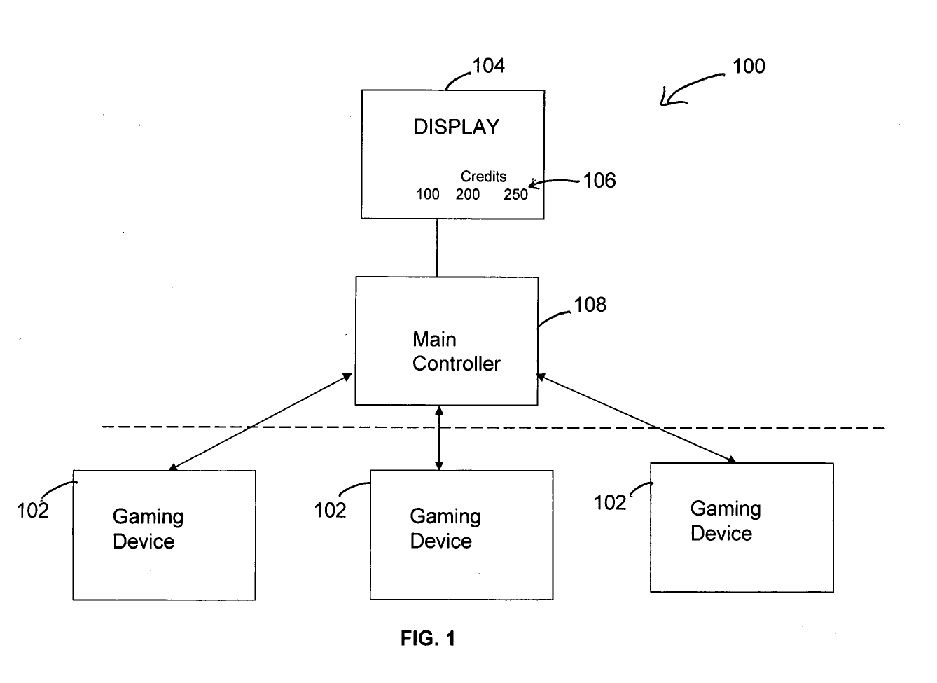

FIG. 1 depicts system 100 for providing random community bonus awards according to an exemplary embodiment of the present invention.

System 100 includes a plurality of gaming device 102 and display 104. Although not shown, other components of system 100 may include a network, controllers and various other network elements.

Gaming device 102 is a computing device that can support one or more different game types. For example, video poker game, video slot game, keno, blackjack, and other games can be provided. Although not necessary, gaming device 102 is preferably networked. In one example, each gaming device 102 is networked with controller 108 that interfaces with display 104.

Display 104 can display bonus awards for the random community bonus. Display 104 may be a large display that is centrally located, positioned around and/or is visible to gaming device 102 users. For example, display 104 may be centered within a circular arrangement of gaming devices. Other positions may also be appreciated. For example, display 104 may itself be located on each of gaming device 102.

In one embodiment, the placement of display 104 is such that players are either attracted to or continue to play their game. For example, display 104 is positioned such that when bonus awards e.g., award 106 are awarded, other proximately located players can become aware of the awards. As large awards are displayed, eligible players can qualify for those awards, thus increasing overall game participation. Further, as large awards are displayed, players who are qualified for one of those awards may continue to play.

Eligibility for the bonus game may be determined for players in different kinds of ways such as, playing the game, betting the max credits, playing an extra coin, inserting of a player card, etc. Thus, a player playing a video poker game may become eligible for the community bonus game by betting max credits. Moreover, a player might be playing a different primary game such as a slot machine and become eligible by inserting a player card.]

Players may qualify for the community bonus in different ways such as by game outcome, the wager amount, players club status, random or predetermined number of one or more predetermined winning game outcomes, random selection, etc. Examples of game outcomes include receipt of a card combination such as a four-of-a-kind, three of a kind or a combination of symbols in a slot game. The term “qualify,” “qualified” or “qualifying” refers to whether a player participating in a primary game has won or has received a right to receive one or more bonus awards in a community bonus game.”

The community bonus game can be triggered to allocate the random community bonus based on game play events. In one example, a random threshold or maximum is value is determined to trigger awards for the random community bonus. For example, the threshold is a random number of bonus awards out of a maximum number of bonus awards that eligible players are qualified to win, such as six out of ten bonus awards. Every time a player qualifies one of the bonus awards are counted. When the number of qualified players equals the randomly selected threshold value the community bonus game is triggered. This random threshold is typically a value equal to or less than the maximum number of individual gaming machines that is used for the community bonus game. Since this threshold is randomly selected, players do not know when the random bonus is triggered.

The community bonus game may comprise different bonus rounds. One bonus round may have a threshold of 6 bonus awards out of 10 bonus awards. The next bonus round may have a threshold of 4 bonus awards out of 10 bonus awards. An advantage of the present invention is that the randomness of the threshold keeps eligible players playing the game until the threshold is reached. In this manner, player appeal and excitement is maintained at high levels.

Another advantage of the present invention is that new players become desirous of playing gaming device 102 as more players qualify for the community bonus since the threshold is reached quicker. For example, if the maximum number of bonus awards is 10, if six eligible players have qualified, then the community bonus game triggers within the next four players qualifying (i.e., at most four more players need to qualify).

This may attract more users to play gaming device 102 as they want a chance to qualify and win the random community bonus. Because the community bonus is random, game play may not drop off when the random community bonus is won and starts over. This is because the threshold could easily be randomly determined to be a low number, such as two, thus there are always a chance the threshold could be hit even after a win.

Players may qualify based on the events that they receive. Every time an eligible player receives a “Full House”, for example, the player qualifies for the bonus game. If a threshold for the number of “Full Houses” received is determined, the random community bonus is triggered when the random number of “Full Houses” is received by eligible players. In one example, the events may be randomly determined, such as a randomly-determined game outcome. For example, the event may be a four-of-a-kind and if it is received by an eligible player, then the player may qualify for a bonus award.

The event that qualifies a player may be different for different players. For example, a player who has a higher standing in the player tracking system (e.g., the player is a platinum member) may have an event that is more likely to happen (e.g., a two-of-a-kind game outcome instead of a four-of-a-kind game outcome).

The event may also be randomly determined for every game played or periodically. For example, for every game, a different game outcome is determined that can qualify the player for the community bonus. Also, over time, different events may be randomly determined, such as for ten game plays, a four-of-a-kind qualifies the player for the community bonus; for the next two game plays, a flush qualifies the player; and then for the next ten game plays, a four-of-a-kind qualifies the player.

Also, if time periods are provided where a two-of-a-kind jacks or better qualifies a player for the community bonus for five minutes, this may increase game play during those five minutes because the player perceives a two-of-a-kind jacks or better is easier to receive and thus plays as many hands as possible during these five minutes.

As players qualify for the random community bonus, the corresponding awards are reflected by display 104. For example, display 104 may initially have all bonus values masked. As players qualify, the bonus values become unmasked. Note that these values may be randomly generated. There might be a pool in which to generate the awards. The awards are randomly generated between a min. e.g., 25 credits and a max e.g., 500 credits based on an average value e.g., 100 credits.

However, over time the average value and the randomly generated awards value may be substantially the same. This injects randomness into the amounts of bonus awards and may create excitement in the play. For example, the random amounts may be 155, 75, 95, etc. when an average value is 100. The average of the random amounts may be around 100 but the random awards that are generated are random.

In other embodiments, the bonus awards may be unmasked. For example, large amounts and smaller amounts may be unmasked. Note that the unmasked amounts may be random. For example, weights may be applied to the values of the awards. A higher weight may be applied to the lower awards. In this case, it is more likely that a lower award is unmasked. However, there is still a chance that the higher awards may be unmasked. With the weightings, a gaming establishment is insured that the highest awards are not always being unmasked.

Thus, if the threshold is six out of ten awards, it is possible that some awards may not be awarded. The weightings may skew the probability of the highest awards being part of the four awards that are not unmasked and thus not awarded. For example, there may be a large award, such as 1,000,000 dollars or credits. This large award may only be unmasked 1 out of 100 bonus rounds while awards of 100 dollars are unmasked 90 out of 100 bonus rounds.

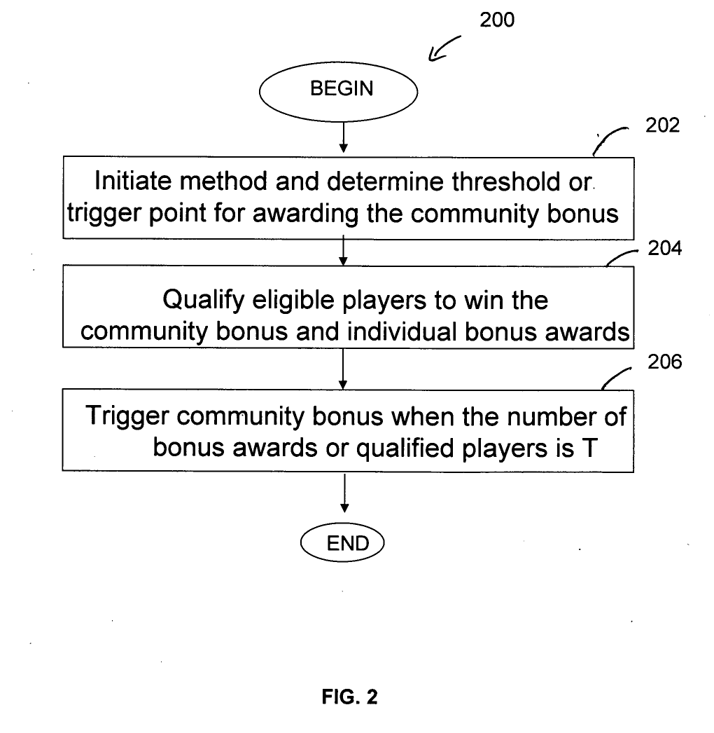

FIG. 2 depicts method 200 in accordance with an exemplary embodiment of the present invention.

In FIG. 2, method 200 can be used for awarding a random community bonus award. The community bonus award itself comprises a number of individual bonus awards. The random community bonus is one that can be awarded to a community of players based on qualification. That is, multiple players may win at least one of the bonus awards that are displayed on display 104. The bonus awards may include credits, points, monetary awards, prizes, goods and the like.

At step 202, method 200 is initiated by determining a trigger point for awarding the community bonus. Note that the term “trigger point” is synonymous with “threshold” in the present specification. The trigger point is the moment in time when the community bonus game grants (or awards) previously earned bonus awards to all of the qualified recipients. In other words, the threshold is the trigger that is used to determine when to award the community bonus.

The trigger point “T” is selected from a range of values, with the maximum value being the number of individual bonus awards that are allocated to the community bonus game. Although not necessary, this maximum value is typically set and displayed to all of the eligible users at the inception of the community bonus game. The displayed value might be displayed as single value e.g., 10 or it might be displayed as a plurality of ten separate bonus awards, in which case the bonus awards can either be masked or unmasked.

At step 204, the bonus game is activated and eligible players are qualified to win the community bonus and the individual bonus awards. Here, note that the term “eligible players” refer to any primary game player that can participate in the bonus game.

Eligibility to participate may be by virtue of playing the underlying primary, betting the max credits, extra coin-in and the like. Different players may have different qualification requirements. The qualification events may be fixed, randomly determined, may vary among different players and can also change periodically.

Here, the number of qualified players cannot be more than the “T” (the trigger point value). Alternatively or in addition, the number of individual bonus awards qualified for can be no more than the value “T.” These individual bonus awards have also not been awarded at this point. The qualified players have merely obtained the right to receive the bonus awards, but only receive the bonus awards upon conclusion of the community bonus game.

In some cases, eligible players might opt-out in which case the bonus awards are either forfeited or a compensatory bonus award is awarded. This compensatory bonus award is typically less relative to the bonus award that would have been received had the eligible player remained until completion of the community bonus game.

As each eligible player qualifies, the bonus award displayed values if unmasked can be increased. If the displayed values are masked or partially masked, they are unmasked as eligible players qualify. A running count of eligible players that have qualified for the community bonus game is also displayed.

At step 206, when the number of bonus awards qualified for reaches the value T, the community bonus is triggered to award at least one bonus award to each of the qualified players.

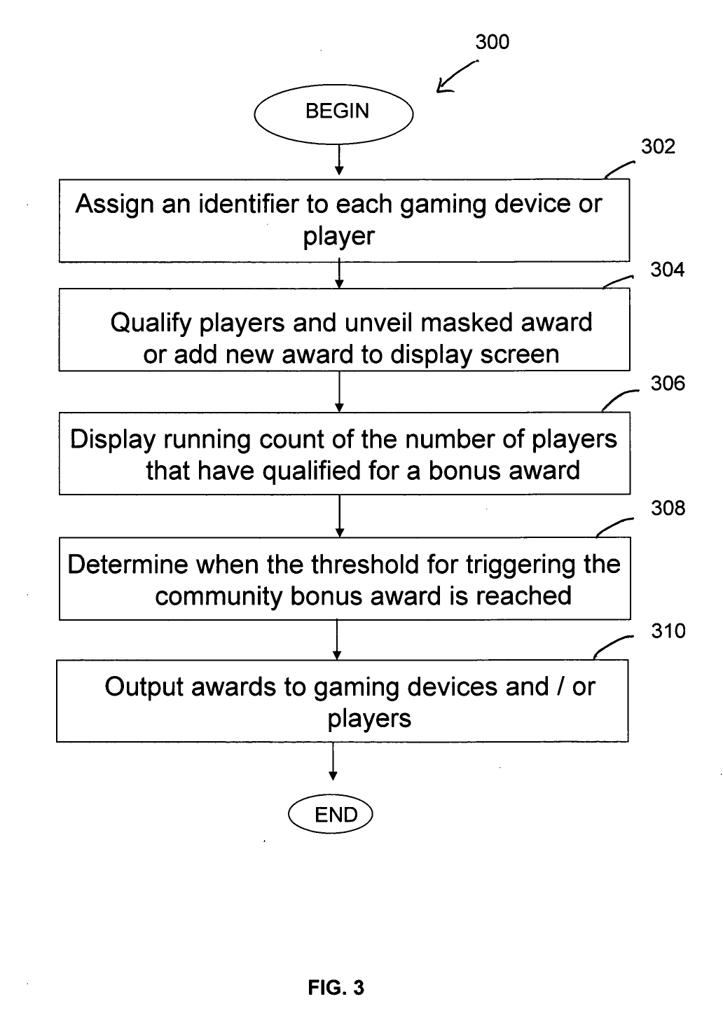

FIG. 3 depicts flowchart 300 for determining awards according to an exemplary embodiment of the present invention.

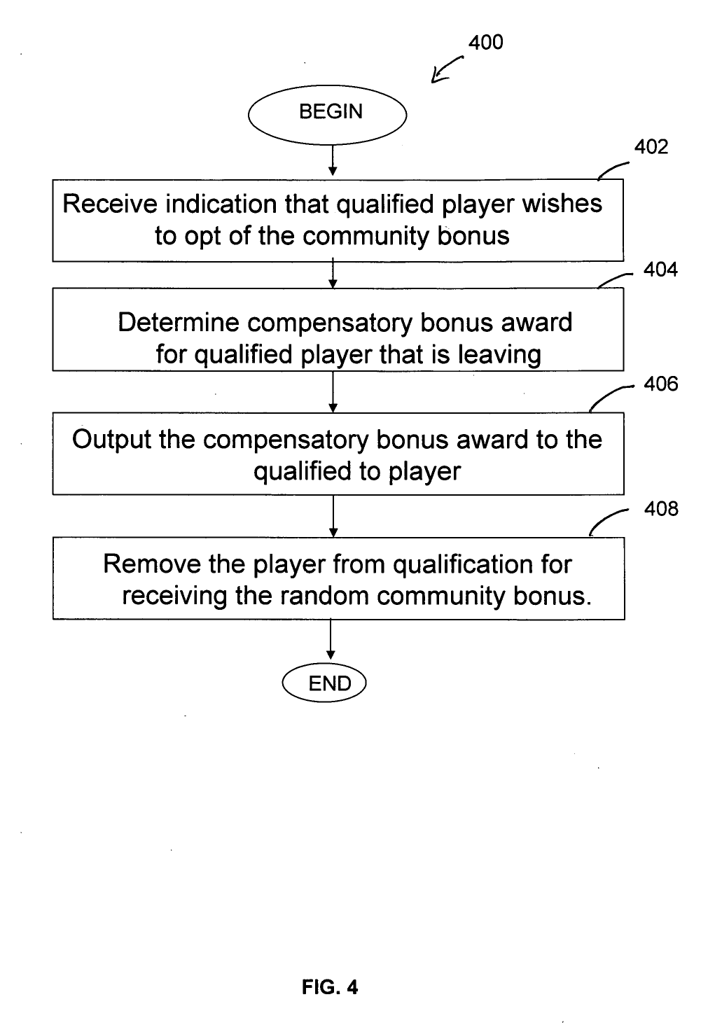

In FIG. 3, step 302 assigns an identifier to gaming device 102 or a player. If a player is using a player-tracking card, an identifier for the player is recorded in the player tracking information. An identifier for gaming device 102 may also be recorded. This identifier information identifies a player that is qualified for the community bonus. In this manner, a controller can use the identifier information to detect when a player removes a player tracking card to terminate a game. In this case, the player might be offered an “opt out” option that is more fully described with reference to FIG. 4, below.

In step 304, an eligible player becomes qualified and a previously-masked award on display 104 is unveiled or a new award is added to the display screen. An award value might also be changed.

Step 306 displays on display 104 a running count of the number of players that have qualified for a bonus award. This may attract other players that see the value of awards is higher and may represent a better chance the threshold will be hit soon.

Step 308 determines when the threshold for triggering the community bonus award is reached. At this threshold point, a bonus award is associated with an identifier for each of the qualified gaming devices or players. The awards may be determined randomly or may have been previously assigned. Also, the awards may be determined based on any kind of heuristics or formula.

Step 310 then outputs the awards to gaming device 102 and/or players. For example, a message is sent to each gaming device 102 that has a qualified player that is receiving an award. Gaming device 102 then outputs a message to the qualified player indicating that they have received a bonus award and also credits the player's account with the value of the bonus award.

As discussed above, a qualified player may want to opt out of waiting for the random community bonus to be awarded. For example, a qualified player may not want to continue playing the game. In this case, a method for a qualified player to opt out and still receive a bonus award is provided. This awards the qualified player but also provides a slight incentive for the qualified player to continue playing. For example, a qualified player may not receive a full bonus award or may receive the smallest bonus award that is being displayed.

FIG. 4 depicts flowchart 400 for allowing a qualified player to opt out according to an exemplary embodiment of the present invention.

In FIG. 4, step 402 receives an input indicating that a qualified player wishes to opt of the community bonus. The qualified player may select an “opt out” option from a menu (not shown) on gaming device 102. Note that as used here, a “qualified” player is a player that has won or has acquired the right to receive one or more bonus awards except that the bonus awards are only awarded upon conclusion of the community bonus.

After the “opt out” option is selected, a confirmation request asking the qualified user to confirm the “opt out” request is displayed. Once confirmed, the “opt out” request is processed.

Step 404 determines a compensatory bonus award. The compensatory bonus awarded provided may depend upon the particular embodiment. If the qualified player has been associated with a bonus award when the player qualified for the bonus, then that bonus awarded may be granted to the qualified player upon leaving. In other cases, if there is no previous association and the bonus award is to be randomly selected upon game conclusion, then the compensatory bonus award granted may be the smallest bonus awards.

In other instances, the compensatory bonus award may be adjusted to a value smaller than the intended bonus awards. As an example, the compensatory bonus award may be adjusted to half of one of the displayed bonus awards. Irrespective, the compensatory bonus awarded granted to the qualified player upon leaving may be of a predetermined value.

Step 406 then outputs the compensatory bonus award to the qualified player.

Step 408 removes the player from qualification for receiving the random community bonus. In this case, the count of qualified players may be reduced by one. Thus, an additional player may be needed to qualify in addition to the remaining players to reach the threshold for triggering the community bonus awards. Reducing the qualified player count of course prolongs the time it takes to reach the threshold.

In other embodiments, the qualified player count is not reduced when a qualified player leaves. The qualified player count is simply maintained as if there had been no player departure. For example, if five players are previously qualified, after which one player departs, the qualified player count number is maintained at five. If the threshold is six, the next player that qualifies then triggers the community bonus since the six threshold is met.

In order to incentivize the remaining players, if qualified players leave and receive reduced awards, the remaining awards are increased by the reduced amount. Thus, if qualified players leave, the remaining qualified players receive this added incentive since the bonus awards displayed are increased by the reduced amount.

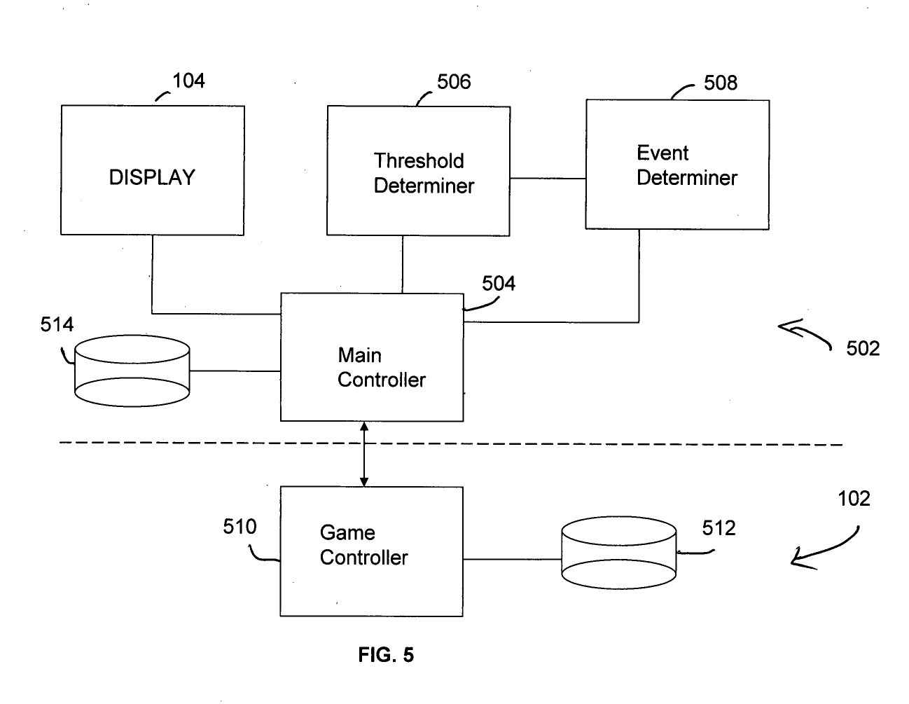

FIG. 5 depicts a more detailed example of a controller of a network-based gaming system according to one embodiment.

Server 502 and gaming device 102 are shown. Server 502 includes main controller 504, threshold determiner 506 and event determiner 508. Server 502 may be any computing device that can control each gaming device 102. Server 502 interacts with gaming device 102 to provide for player qualifying and awarding of bonuses.

Threshold determiner 506 is configured to determine the threshold (or triggering point) that triggers the community bonus. Threshold determiner 506 may include logic that can randomly determine the threshold against a maximum number of individual bonus awards allocated to the community bonus game. For example, a weighted function may used to determine the threshold. Note that the threshold can be larger so that the community bonus is awarded less frequently. However, the randomness is injected such that the threshold can vary between a minimum and a maximum but average a threshold value over time.

Event determiner 508 is configured to determine events in which eligible players can qualify. Although event determiner 508 is shown in server 502, it will be recognized that functions of event determiner 508 may be found in gaming device 102. Event determiner 508 determines which events will allow a player to become qualified for the community bonus and can communicate event messages to gaming device 102. In other embodiments, gaming device 102 may determine which events will allow a player to become qualified for the community bonus.

Main controller 504 receives and sends the threshold and event information to game controller 510 of gaming device 102. Game controller 510 can store the threshold and event trigger in storage 512 so that threshold determination is performed by game controller 510. Main controller 504 may also determine when the threshold is hit. For example, in server-based gaming, game controller 510 may send an indication to main controller 504 that a player is eligible, and main controller 504 may keep a count of the players that are qualified and compare this to a threshold.

In other embodiments, game controller 510 may be in communication with other game controllers through a network. When players qualify for the community bonus, the message may be broadcast among gaming device 102. When the threshold is hit, game controller 510 may then broadcast a message to other gaming device 102 and main controller 504. Furthermore, in a server-based environment players playing gaming devices of different type, style, denominations, etc may all be provided with the opportunity to play in the same bonus game. Events may be determined with equal chance of qualification that allow players playing any of type, style, denomination, etc of gaming device the equal opportunity of winning an award in the bonus game.

Game controller 510 provides one or more games for a player. For example, game controller 510 may include functions known in the art to provide a video poker game, slot game, etc. The events that may occur may be game outcomes and game controller 510 may determine when a player receives the game outcome that qualifies the player for the random community bonus. Also, the events may not be related to game outcome and game controller 510 may determine when these events occur, such as when the player plays a game for a certain amount of time, reaches a certain number of player points, etc.

When a player qualifies, game controller 510 sends a message to main controller 504. Main controller 504 tracks the number of qualified players. Main controller 504 also directs that the information be displayed by display 104. Display 104 may then unmask a bonus award, increase a bonus award, etc. Main controller 504 can also store bonus award information such as identifiers for qualified players in storage 514.

Once the community bonus is triggered, main controller 504 determines the bonus awards for the qualified players. Game controller 510 via display 104 then outputs the bonus award values to each player. For example, display 104 might indicate that the qualified player has won a certain amount while the player's bankroll is credited.

Exemplary embodiments of community bonus games will now be described with continued reference to FIG. 5. In a first exemplary game, the maximum number of bonus awards allocated to the community bonus game is determined and displayed. The number of bonus awards (e.g. ten) may be partially masked or are blank. As eligible players become qualified, the awards are unmasked until a randomly selected threshold is reached.

The unmasked values of the awards may be determined randomly based on various factors. For example, a random award may be based on one or more average values e.g., 50 credits, 75 credits, 100 credits, etc. Between a minimum e.g., 25 credits and a maximum 500 credits, a function using the average value e.g., 50 credits is used to randomly generate a value. This may use a random number generator that is applied to the function along with the minimum, maximum, and average value. The function outputs the randomly generated value. Over time, this value may substantially equal the average value but the values generated are random.

As each eligible player qualifies, different random awards are generated and displayed. By unmasking awards, players see the awards and continue to play. The random generation of awards also allows higher awards to be provided. When the threshold is reached, each of the qualified players is randomly associated with different awards. The associated awards are then granted (awarded) to the qualified player.

In a second embodiment, all of the bonus values remain visible. The bonus awards are randomly generated from a fixed or progressive prize pool and displayed on display screen 104. The bonus awards may be between a minimum (e.g., 50) and a maximum (e.g., 5000) value of a prize pool. Examples of random awards are 234, 546, 789, 1700, 4509, 4340, etc. In another embodiment, the awards may be fixed. An example of fixed awards is 200, 500, 750, 1000, 1500, 4000, 10000, etc. The random awards generated may vary randomly and thus different awards are generated for different bonuses. The fixed awards are the same across multiple games.

In a third game, eligible players can quality for multiple bonus categories in the primary game. Unlike conventional systems, wherein eligible players qualify for only one bonus game, the present invention can allow players to qualify and play two, three or more bonus games contemporaneously.

For example, an eligible player while qualified and playing a “Four of a Kind” bonus game wherein the player earns bonus awards when a “Four a Kind” event occurs, the player can also qualify qualified and play a “Full House” bonus game wherein the player earns bonus awards when a “Full House” is hit. Here, each bonus game has ten bonus awards that are randomly selected from a prize pool.

Each bonus award may be randomly selected from fixed prize pool, which is generated from a predetermined minimum award up to a predetermined maximum award based on at least one average award. Each bonus game also has the opportunity to win the same progressive prize award. For example, (e.g., Four of a Kind 25 credits up to 300 credits based on a average award of 50 credits, “Full House” 15 credits up to 500 credits based on a average award of 30 credits).

### Progressive Prize Award $1,004,586

### Four of a Kind Bonus Awards:

| | | | | |
|---|---|---|---|---|
| 30 credits | 45 credits | 100 credits | 340 credits | 75 credits |
| 40 credits | 240 credits | 370 credits | 124 credits | 400 credits |

### Full House Bonus Awards:

| | | | | | |
|---|---|---|---|---|---|
| 25 credits | 35 credits | 230 credits | 60 credits | 55 | credits |
| 15 credits | 85 credits | 180 credits | 65 credits | 270 | credit |

For each bonus game a random threshold event is selected between a minimum and maximum number of bonus awards to trigger a community bonus for each of the bonus games. As an example, for the “Four of a Kind” bonus game, a random number of four of a kinds (e.g., 3) are selected between a predetermined and/or randomly selected minimum (e.g., 3) and a maximum (e.g., 10) number of four of a kinds and for the “Full House” bonus game, a random number of full houses (e.g., 7) are selected between a minimum (e.g., 5) and a maximum (e.g., 10) for the community bonus game.

In this embodiment, when an eligible player receives a “Four of a Kind” the player becomes eligible for the “Four of a Kind” bonus game and this four of a kind event is counted and stored in the system's controller. When a threshold event is then received, one of the bonus awards for that category may be randomly selected and increased by a random or fixed value. For example, a random value between a minimum (e.g., 5 credits) and maximum value (e.g., 100 credits) based on an average value (e.g., 35 credits is generated (e.g., 65 credits) may be added to one of the bonus categories awards.

### “Four of a Kind” Bonus Awards:

| | | | | |
|---|---|---|---|---|
| 30 credits | 45 credits | 165 credits | 340 credits | 75 credits |
| 40 credits | 240 credits | 370 credits | 124 credits | 400 credits |

As eligible players receive one of the qualifying events (e.g., “Four of a Kind” or “Full House”) the players qualify for that bonus category. A player's machine can be identified with a number in order to identify each player that is qualified. The qualified players are also displayed in all the gaming devices screens that are connected to the system and/or on an overhead display.

### Four of a Kind Qualified Players:

| | | |
|---|---|---|
| Machine 1 qualified | Machine 6 qualified | Machine 4 qualified |

### Four of a Kind Bonus Awards:

| | | | | |
|---|---|---|---|---|
| 30 credits | 45 credits | 165 credits | 340 credits | 75 credits |
| 40 credits | 290 credits | 370 credits | 124 credits | 400 credits |

Once one of the bonus categories is triggered (e.g., “Four of a Kind”) each eligible player is awarded a randomly selected bonus award from the category.

### Four of a Kind Winner:

| | | |
|---|---|---|
| Machine 1-30 credits | Machine 6-124 credits | Machine 4-290 credits |

After qualified players are awarded their bonus awards, new awards are generated for the bonus awards that are paid and the other awards remain for the next bonus game.

### Four of a Kind Bonus Awards:

| | | | | |
|---|---|---|---|---|
| 60 credits | 45 credits | 165 credits | 340 credits | 75 credits |
| 40 credits | 190 credits | 370 credits | 44 credits | 400 credits |

Once the qualified players have been paid a new threshold is selected for the bonus category that was just played and game play resumes as normal until another bonus category is triggered. A threshold (e.g., 5 “Full Houses”) may be selected that is needed to trigger at least one award for the random community bonus game.

The events that may make a player qualified for the random community bonus may be random also but in this embodiment it may be a predetermined winning game outcome such as the winning combination of a “Full House”). As players qualify, one or more of the awards may increase in value.

The increase in value may be randomly generated or may be a fixed amount. For example, awards may increase by a certain amount, such as $50 or 50 credits each time a player qualifies. Thus, if the threshold is high, then more players need to qualify. This increases the values of awards that are displayed over time and may attract more players. When the threshold is hit, the awards may be awarded to the players that have qualified. For example, for each of the qualified players one of the community bonuses may be randomly selected.

If qualified players decide to opt out before the community bonus is awarded, then the qualified players may be awarded the increase in value but not the base value. For example, the increase in value that was generated when a player became eligible may be awarded to that player.

However, the player does not receive the base value. In one example, the award may have started at 1000 credits and was increased to 1250 credits. A player opting out would receive the 250 credits but not the 1000 credits. In another embodiment, a fixed award maybe awarded to the players who decide to opt out before the community bonus game. In another embodiment, an award may be randomly generated for the qualified player who decided to opt out.

Although the description has been described with respect to particular embodiments thereof, these particular embodiments are merely illustrative, and not restrictive. Although casino games are discussed, it will be understood that other games may be used.

Any suitable programming language can be used to implement the routines of particular embodiments including C, C++, Java, assembly language, etc. Different programming techniques can be employed such as procedural or object oriented.

The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. In a casino gaming computer network having a plurality of networked gaming machines played by a community of individual players, said casino gaming computer network having a central display that is visible to said individual players, a method for awarding a community bonus consisting of a plurality of bonus awards, said method comprising:
determining a trigger point that awards said community bonus, wherein said trigger point is represented by a number T, wherein said number T is selected from a range of values 1 through M, wherein M represents the maximum number of individual bonus awards that are allocated to said community bonus game;
initiating said community bonus game play and qualifying one or more players for said community bonus, wherein said number of said players qualified is no more than said number T, wherein although qualified to win said community bonus, said one or more qualified players are not yet awarded said bonus awards; and
wherein when said number of qualified players reaches said number T, triggering said community bonus to award at least one bonus award to each of said qualified T players.

2. The method of claim 1 further comprising awarding a compensatory bonus award to a player that leaves prior to conclusion of said community bonus.

3. A method comprising:
determining a trigger point that awards a community bonus consisting of a plurality of bonus awards, wherein said trigger point is represented by a number T, wherein said number T is selected from a range of values 1 through M, wherein M represents the maximum number of individual bonus awards that are allocated to said community bonus game;
initiating bonus game play and qualifying one or more players to win said plurality of bonus awards, wherein the number of plurality of bonus awards qualified for is no more than said number T, wherein although qualified to win said community bonus, said one or more qualified players are not yet awarded said bonus awards; and
wherein upon said number of bonus awards qualified for reaching said number T, triggering said community bonus to award at least one bonus award to each of said qualified players.

4. The method of claim 3 wherein M is fixed at inception of said community bonus and is displayed for viewing by all users.

5. The method of claim 3 further comprising displaying unmasked values for said plurality of bonus awards.

6. The method of claim 3 further comprising displaying masked values for said plurality of bonus awards.

7. The method of claim 5 wherein each of said displayed unmasked values is increased as each eligible player qualifies.

8. The method of claim 6 wherein each of said displayed masked values is unmasked as each eligible player qualifies.

9. The method of claim 3 further comprising displaying a running count of eligible players that have qualified for said community bonus game.

10. In a casino gaming computer network having a plurality of networked gaming machines played by a community of individual users, said casino gaming computer network having a central display screen that is visible to said individual users, a method for awarding a community bonus consisting of a plurality of bonus awards, the method comprising:
determining a trigger point that awards said community bonus and said plurality of bonus awards, wherein said plurality of bonus awards are displayed on a display screen, and wherein said trigger point is represented by a number T, wherein said number T is a randomly selected maximum value;
initiating said community bonus game play to qualify one or more users for said community bonus, wherein the number of said users qualified is no more than said number T, wherein although qualified to win said community bonus, said one or more qualified users are not yet awarded said bonus awards; and
wherein when said number of qualified users reaches said number T, triggering said community bonus to award at least one bonus award to each of said qualified T users.

11. The method of claim 10 further comprising awarding a compensation bonus award to a user that opts-out prior to conclusion of said community bonus, wherein said compensation bonus award is no more than the smallest bonus award received by a remaining qualified user.

12. The method of claim 10 further comprising displaying unmasked values for said plurality of bonus awards.

13. The method of claim 10 further comprising displaying masked values for said plurality of bonus awards.

14. The method of claim 12 wherein each of said displayed unmasked values is increased as each eligible player qualifies.

15. The method of claim 13 wherein each of said displayed masked values is unmasked as each eligible player qualifies.

16. The method of claim 10 further comprising displaying a running count of eligible players that have qualified for said community bonus game.

17. A casino gaming system comprising:
a central controller;
a central display screen, communicably coupled to said central controller;
a plurality of gaming machines, each gaming machine having a local controller, each of said plurality of gaming machines being communicably coupled to said central controller and central display screen, wherein said central display screen is visible to users of said plurality of gaming machines,
wherein said plurality of gaming machines are configured to be operable in a community bonus mode,
wherein said central controller is configured to award a community bonus consisting of a plurality of bonus awards to said users and wherein said central display screen is configured to display said plurality of bonus awards,
wherein said central controller is configured to determine a trigger point that awards said plurality of bonus awards, wherein said trigger point is represented by a number T, wherein said number T is a randomly selected maximum value,
wherein said central controller is configured to initiate community bonus game play and qualify said users for said community bonus, wherein the number of said users qualified is no more than said number T, and
wherein when said number of qualified users reaches said number T, said central controller is configured to trigger said community bonus to award at least one bonus award to each of said qualified T users.

18. The casino gaming system of claim 17 wherein said central display is configured to display a running count of eligible users that have qualified for said community bonus.

19. The method of claim 3 further comprising awarding a compensatory bonus to a player that leaves prior to conclusion of said community bonus, wherein said compensatory bonus is less than bonus awards received by remaining qualified players.
